(19) United States
(12) Patent Application Publication
(10) Pub. No.: US 2015/0363374 A1
(43) Pub. Date: Dec. 17, 2015

(54) Method and System for Providing a Programming Interface Specification

(71) Applicant: FixSpec Limited, Surrey (GB)

(72) Inventor: Chris Lees, Surrey (GB)

(21) Appl. No.: 14/305,730

(22) Filed: Jun. 16, 2014

(51) Int. Cl. G06F 17/24; G06Q 40/00; H04L 12/58; G06Q 10/10

(52) U.S. Cl. CPC G06F 17/24; G06Q 10/10; G06Q 40/00; H04L 51/04

(57) ABSTRACT

A method and system is disclosed for providing a programming interface (PI) specification which defines in text form the format of data messages for communication between, for example, financial services counterparties for making transactions. The system includes one or more physical processor in communication with physical data storage, the one or more processors being configured to: provide in data form a base PI specification for display on a computer; send said base PI specification, or a copy thereof, to a computer for display and editing through a user-interface; receive from said computer at least one edit made to said base PI specification through the user-interface; provide a sub-specification of said base PI specification incorporating the at least one edit made in (iii); and make the sub-specification available for viewing at remote computers over a data network.

### FIELD OF THE DISCLOSURE

This invention relates to a method and system for providing a programming interface specification, particularly one in electronic data form for viewing on a computer terminal

### BACKGROUND OF THE DISCLOSURE

Financial Services Counterparties use a wide range of protocols to electronically communicate information relating e.g. to real-time financial or securities transactions. Such counterparties include banks, investment managers, brokers, exchanges, networks and settlement agencies, amongst others. The major industry standard protocols are Financial Information eXchange (FIX) and ISO 15022/20022 (SWIFT) although others are available.

An example Counterparties setup is a communications channel between an exchange computer network and a broker computer network. An industry standard protocol will be used over the channel with the exchange operating an Application Programme Interface (API) to their service which the broker has to adhere to for communications. The API in this context defines how the computer systems of the two parties should construct, transmit and interpret message using that protocol. Another example setup is a communications channel between a broker and a client, for example a pension fund, which may use the same or a different protocol with the broker providing an API to their service which the pension fund uses to communicate transactions with the broker.

Industry standard protocols typically define supersets of functionality (represented as messages, fields, permitted enumerations and descriptions) covering a wide range of scenarios. As supersets, the protocols allow flexibility for practitioners to customise functionality which is relevant for their particular implementation, whether this involves removing, adjusting, and/or extending functionality. In effect, a destination-specific customisation of the API protocol is created to which senders, e.g. the client, must program.

Counterparties offering a customised API to their service (an API provider) use documentation relevant to the base standard protocol as a guide, and manually adjust this documentation as necessary, before publishing their destination-specific API in a suitable form, for example as a PDF document. Although the content varies, the presentation layout of this documentation is strikingly similar across different customised offerings. A small number of API providers present their API documentation as an HTML page on their website, using the same layout as the PDF version.

Market utilities such as stock exchanges and settlement agencies typically publish their API documentation on a website and expect all customers to adhere to it strictly. Banks, brokers and networks typically do not publish the API documentation publicly and almost always accept customer/client requests to override or adjust their base API so that these customers can use a customised version of the API that best suits their needs.

The current process for capturing and implementing customisations is manual and performed at the initial customer on-boarding/testing phase.

### SUMMARY

A first aspect of the present disclosure provides a method of providing a programming interface (PI) specification which defines in text form the format of data messages for communication between financial services counterparties for making transactions, the method comprising:
(i) providing in data form a base PI specification for display on a computer;
(ii) sending said base PI specification, or a copy thereof, to a computer for display and editing through a user-interface;
(iii) receiving from said computer at least one edit made to said base PI specification through the user-interface;
(iv) providing a sub-specification of said base PI specification incorporating the at least one edit made in (iii);
(v) making the sub-specification available for viewing at remote computers over a data network.

Step (ii) may further comprise indicating through the user-interface one or more defined parts of said base PI specification that can be edited.

Step (i) may comprise providing a base PI specification comprising a plurality of message types, and, for each message type, a technical specification comprising a plurality of fields and associated parameters, and wherein step (iii) comprises receiving at least one edit which defines for a message type a restricted version of the technical specification limited for a respective use case.

The method may further comprise, prior to step (v), providing a selectable indication of the respective use case for display at a remote computer, selection of which makes the associated sub-specification available for viewing in step (v).

The edit received in step (iii) may be associated with a given user or user-group, and wherein step (iv) comprises providing the sub-specification in response to detecting a display request received from said user or user-group.

The edit received in step (iii) may be associated with a first user-group, and in which the method further comprises receiving at least one edit to the sub-specification PI to be associated with a subset of said first user-group, and subsequently providing a second sub-specification to the subset user(s).

Step (ii) may comprise sending said base PI specification, or copy thereof, as an editable form or table.

Step (ii) may comprise sending said base PI specification, or copy thereof, in editable form which enables textual notes to be added to the technical specification of a message type.

Step (ii) may comprise sending said base PI specification, or copy thereof, in editable form which enables the restriction of field parameters.

Step (ii) may comprise sending said base PI specification, or copy thereof, in editable form which non-mandatory fields and/or associated parameters to be made mandatory.

The method may further comprise, subsequent to step (iii), the step of determining if a received edit is permitted and in step (iv) providing a sub-specification including only a permitted edit. Predetermined rules may be provided to automatically determine whether an edit is permitted or not.

The method may further comprise generating computer-readable instructions for modifying a programming interface in response to an edit received.

The base PI specification and sub-specification may be provided in a mark-up language for display in a graphical user interface (GUI) at a remote computer.

The method may further comprise generating in response to a remote request a fixed version of the sub-specification and providing access to said fixed version by a remote user.

The method may further comprise the step of proposing edits to the base PI specification and assessing the impact of said proposed edits on the or each sub-specification associated with the base PI specification.

The method may be performed at a computer system of, or associated with, a PI provider, wherein step (ii) comprises sending said base PI specification to a computer of a PI user, step (iii) comprises receiving the at least one edit from the PI user computer, and step (v) comprises making the sub-specification available for viewing at the PU user computer.

A second aspect of the present disclosure provides a system configured to provide a programming interface (PI) specification which defines in text form the format of data messages for communication between financial services counterparties for making transactions, the system comprising:

one or more physical computers in communication with physical data storage, the one or more processors being configured to:
(i) provide in data form a base PI specification for display on a computer;
(ii) send said base PI specification, or a copy thereof, to a computer for display and editing through a user-interface;
(iii) receive from said computer at least one edit made to said base PI specification through the user-interface;
(iv) provide a sub-specification of said base PI specification incorporating the at least one edit made in (iii); and
(v) make the sub-specification available for viewing at remote computers over a data network.

A third aspect of the present disclosure provides non-transitory computer storage having stored thereon instructions that, when executed by a computer system having computer storage, cause the computer system to perform a method of providing a programming interface (PI) specification which defines in text form the format of data messages for communication between financial services counterparties for making transactions, the method comprising:
(i) providing in data form a base PI specification for display on a computer;
(ii) sending said base PI specification, or a copy thereof, to a computer for display and editing through a user-interface;
(iii) receiving from said computer at least one edit made to said base PI specification through the user-interface;
(iv) providing a sub-specification of said base PI specification incorporating the at least one edit made in (iii);
(v) making the sub-specification available for viewing at remote computers over a data network.

A fourth aspect of the present disclosure provides a method comprising:
(i) storing a PI specification which defines how a user financial services counterparty should send data to a provider counterparty over a data communications network;
(ii) providing access to a displayable, interactive version of said PI specification to enable editing of said PI specification;
(iii) receiving one or more edits made to the interactive version of said PI specification and generating a sub-specification incorporating the or each edit;
(iv) providing access to the sub-specification over a data communications network.

A fifth aspect of the present disclosure provides a method of providing a programming interface (PI) specification which defines in text form the format of data messages for communication between computers, the method comprising:
(i) providing in data form a PI specification for display on a computer;
(ii) defining one or more parts of said PI specification that can be edited;
(iii) sending said PI specification over a data network to at least one remote computer for display;
(iv) receiving from the remote computer system at least one edit made to said PI specification; and
(v) subsequently providing over a data network an updated PI specification, or part thereof, for display on a computer which incorporates the at least one edit made in step (iv).

The PI specification may define the format of data messages for communication between financial services counterparties for making financial services transactions, and defines a plurality of message types, and, for each message type, a set of fields and parameters.

A sixth aspect of the present disclosure provides a method of providing a programming interface (PI) specification which defines in text form the format of data messages for communication between computer systems, the method comprising:
(i) providing in data form a base PI specification which comprises a plurality of message types, and, for each message type, a technical specification comprising a plurality of fields and associated parameters;
(ii) for at least one of said message types, providing one or more restricted version(s) of the technical specification limited for a respective use case;
(iii) providing over a data network to a remote user a graphical interface for displaying an indication of the or each restricted version; and
(iv) receiving selection of a restricted version from a remote user, and responsive thereto, providing display of the associated technical specification.

A seventh aspect of the present disclosure provides a method of providing a programming interface (PI) specification which defines in text form the format of data messages for communication between financial services counterparties for making financial services transactions, the method comprising:
(i) providing in data form a base PI specification arranged into message types with associated parameters;
(ii) creating for at least one of the message types at least one alternative definition in which the associated parameters are restricted for a particular respective use case;
(iii) providing for selective display at a remote computer system the base PI specification and the alternative definition(s).

An eighth aspect of the present disclosure provides a method of managing a programming interface (PI) specification which defines in text form the format of data messages for communication between financial services counterparties for making financial services transactions, the method comprising:
(i) providing in data form a PI specification for display at one or more remote computer systems using a data network;
(ii) storing for one or more remote users a customized version of said PI specification;
(iii) editing the electronic form PI specification to propose a change; and
(iv) automatically generating an impact report indicating the effect of the proposed change on the customized version.

### BRIEF DESCRIPTION OF THE DRAWINGS

One or more aspects of the present disclosure will now be described, by way of non-limiting example, with reference to the drawings, in which:

FIG. 1 is a block diagram of a typical computer network comprising different financial services counterparties;

FIG. 2 is a block diagram showing functional modules of a counterparty system according to an aspect of the present disclosure, shown connected to a customer terminal;

FIG. 3 is a block diagram showing hardware modules of a programming interface control terminal according to an aspect of the present disclosure, which forms part of the counterparty system shown in FIG. 2;

FIG. 4 is a block diagram showing software modules of an API application according to an aspect of the present disclosure, shown in FIG. 3;

FIG. 5 is a screen shot showing a technical view of part of an API specification;

FIG. 6 is a block diagram showing schematically the linking of functional views of part of the API specification to a parent technical view;

FIG. 7 is a flow diagram showing processing steps performed by the API application in creating a functional view from a parent technical view;

FIG. 8 is a screen shot showing a functional view of part of an API specification;

FIGS. 9A-9G are flow diagrams showing processing steps performed by the API application which are used to constrain edits made to the API specification;

FIG. 10 is a block diagram showing schematically the relationship between an API provider, an API user and API sub-users;

FIG. 11 is a flow diagram showing processing stages performed at a customer terminal and API control terminal in handling proposed edits to part of an API specification;

FIG. 12 is a screen shot showing a customised user view of part of an API specification;

FIG. 13A shows for comparison processes performed by the API application in providing first and second customisation modes;

FIG. 13B is a screenshot indicating how an API change can be requested through a specification portal;

FIGS. 14A and 14B present, respectively, pseudo code and an associated flow diagram indicating a change made to an API;

FIGS. 15A and 15B present, respectively, pseudo code and workflows for defaulting fields;

FIGS. 16A and 16B present, respectively, pseudo code and workflows for deleting fields;

FIG. 17 is a screen shot of an example impact matrix, used as part of a process for generating a change impact report; and

FIG. 18 is a flow diagram indicating processing stages of the API application in generating a change impact report.

### DETAILED DESCRIPTION OF ILLUSTRATIVE EMBODIMENTS

API documentation may change over time as the functionality offered by the API provider changes. The frequency by which it changes varies significantly depending on the service offered and its maturity, from multiple monthly updates to one update every few years.

The inventor of the present patent application has learned that this current, manual, process can result in one or more problems.

For example, PDF is an unhelpful format for API documentation because it is not machine-readable and comparing versions is a manual task. The documentation can be over 300 pages long and so developers typically program to an API by submitting boilerplate messages based on the underlying base standards and use the PDF to troubleshoot inevitable errors. This approach is time-consuming, and error-prone, frequently leaving developers unaware of nuances or clarifications explained in unread parts of the customised API document.

In another example, the customised API documentation is usually indexed according to technical messaging, e.g. the message to logon, the message to send an order to a broker, the message returned to confirm an order. A single message may handle multiple sub-types which may in turn lead to conditional relationships within a single message. For example, a common New Order message may be used to send both of the following sub-types, which in turn have different requirements with respect to a Price field:
1) A “Limit Order” is an instruction to buy or sell some asset at a Price no worse than a specific price. The Price field is mandatory.
2) A “Market Order” is an instruction to buy or sell some asset at the best current Price in the market. As the order will accept any price, the Price field should not be present in such a message.

These functionality-specific conditional relationships between field, and permitted field enumerations, in a technical message create significant complexity in the documentation which can cause errors.

In another example, customers rarely require all functionality offered by an API provider, yet the documentation will present the full range of options available. This creates issues, including:
1) The customer must filter the documentation and extract only the information required for its application, and must review all documentation updates to determine if the update applies to the subset they use in practice.
2) The API provider has no feedback mechanism to inform it which functionality is or are of interest and being developed by its customers.

In another example, if the API provider allows adjustments to its API, the current manual process of capturing and documenting these customer-specific adjustments is inefficient and error prone. For example, there is typically no warning mechanism to alert the API provider that a change they are about to make to their API will conflict with a customer specific override.

One or more embodiments of the present disclosure, as discussed below, optionally may overcome one or more of these problems.

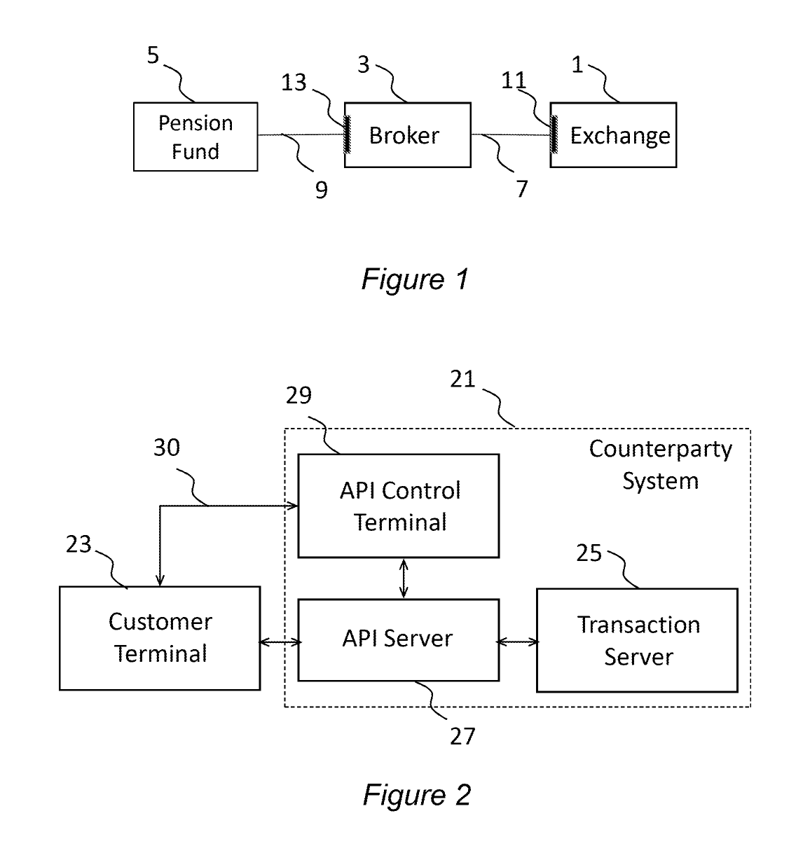

FIG. 1 indicates a typical computer system set-up between different Financial Services Counterparties, in this case an exchange 1, a broker 3 and a pension fund 5. Between each Counterparty computer system 1, 3, 5 is an electronic data communications channel 7, 9 which can be of any suitable form but will usually be a physical channel. A data communications protocol is employed over each channel 7, 9 in order for real-time financial transactions to be communicated from/to the customer party to/from its provider counterparty.

The exchange 1 provides an API 11 which the broker 3 has to configure its own systems to adhere to. In practise, this will usually be fixed with little or no opportunity for customisation to suit requirements or preferences of the broker 3. The broker 3 provides its own API 13 which can however be customised based on requirements or preferences of individual client(s), which in this case is the pension fund 5. Other customers of the broker 3 may have different requirements and hence different flavours of the API 13 can be provided for different clients.

Although embodiments herein relate to an API between financial services counterparties, the same principles can be employed for other programming interfaces (PI) between any type of organisation. A programming interface typically defines the format of data messages, e.g. a data communications protocol, that one party's computer system (or application running on their computer system) accepts from another party's computer system (or application running on their computer system), over a data communications channel for correct operation. One example of an alternative embodiment is the transmission of electronic health records between systems which use one of the wide variety of possible standards. The sending healthcare system may not require the full range of services provided by the receiving API, and it may be very costly or difficult to change the sending systems messaging to strictly adhere to the published API of the receiving system.

Embodiments to be described relate to systems and methods providing documentation in electronic format, and therefore communicated in data form for display, relating to an API specification, which documentation can be tailored at the API provider-end to better meet the needs of its API users in terms of how it is presented to them in a more intelligible and intuitive way, including providing different technical and functional views, to be described later on. Features are provided to ensure consistency between views as and when changes are proposed. Later embodiments also provide systems and methods whereby in a customised user view API users can provide over a data link proposals to the API provider on modifications or customisations they would like applied to the API, which proposals is or are provided in terms of changes made interactively to the electronic API documentation. This may then be sent for review at the API provider-end whereafter the proposals can be checked for consistency and either approved or rejected.

A first embodiment includes an API system which in this particular example is provided at the broker location 3 but can in practice be provided at any counterparty location. References to “API provider” in the following refer to the counterparty computer system that provides the customisable API system and “API user” is any counterparty computer system that uses the API provider's API.

FIG. 2 shows a first embodiment counterparty system 21 which may be the broker computer system 3. An external customer terminal 23 is shown connected to it, which can represent a computer system or computer network of the pension fund 5 which communicates messages with the counterparty system 21 according to an API. The counterparty system 21 includes a transaction server 25 which is where financial services transactions are performed, e.g. the buying/selling of securities, in response to messages interpreted by an API server 27 which, as the name suggests, provides the API.

The API server 27 is a standard computer system running on its processor the API software which receives and decodes/interprets incoming messages for performing transactions on the transaction server 25. It also passes outgoing messages, e.g. confirmations, back to API users, including the customer terminal 23. The API server 27 need not be provided on a dedicated terminal. The API server 27 in use may receive messages from multiple different API users' computer systems and includes suitable client identification methods. Different versions or flavours of API may be made available for different API users, although for the purposes of this description, just one API user operating the customer terminal 23 is assumed.

The API control terminal 29 is configured to provide in electronic format the documentation defining the API, including the technical specification of the API, and other so-called functional views, for access, display and reading by the customer terminal 23 over a data communications channel 30. This documentation is required to enable the API user's developers to configure their own systems and software to correctly communicate with the API in the API server 27 in order to perform transactions on the transaction server 25. As will be explained later on, the API control terminal 29 in some embodiments is also configured to apply customisation changes to the API itself, whether these are invoked by the API provider or requested via the control terminal by the API users' computer system 23. Changes suggested by the API user pass over the communications channel 30.

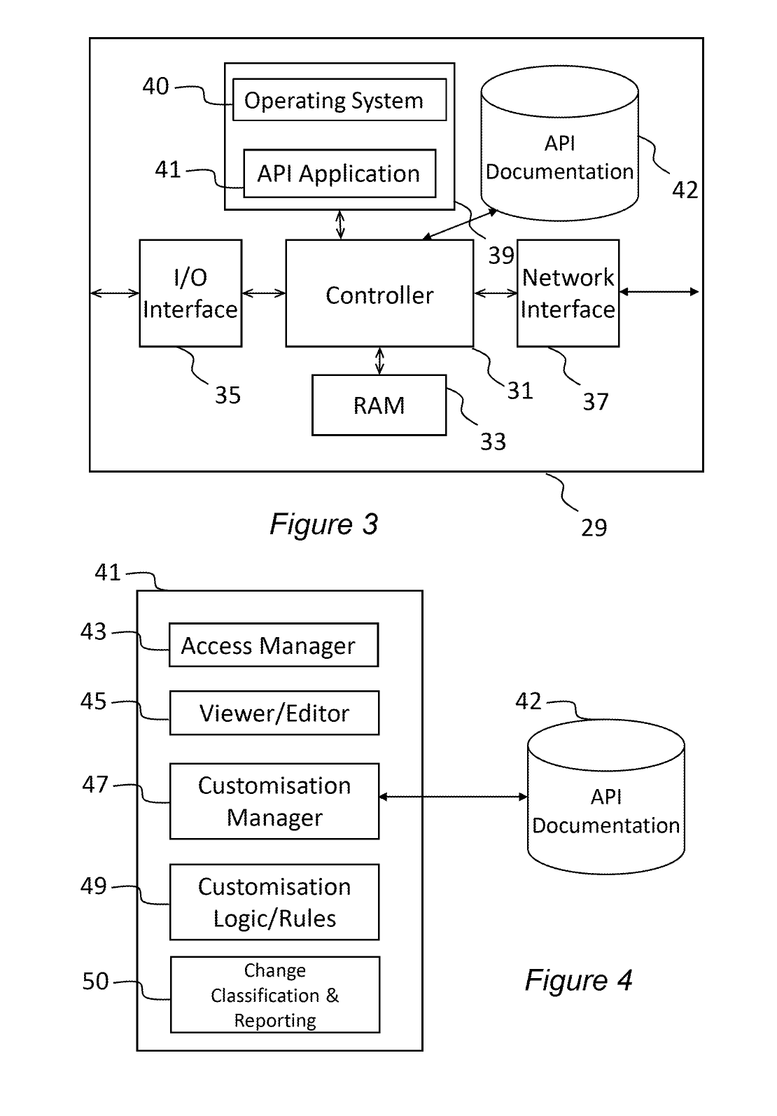

FIG. 3 shows functional modules within the API control terminal 29, which include a controller device 31, RAM 33, an input and output (I/O) interface 35, a network interface 37, memory 39 and an API documentation database 42. The controller 31 is connected to each of the other components in order to control operation thereof. The API documentation database 42 stores in electronic format the API documentation.

The memory 39 may be a non-volatile memory such as read only memory (ROM) a hard disk drive (HDD) or a solid state drive (SSD). The memory 39 stores, amongst other things, an operating system 40 and an API Application 41. Other applications and data may be stored on the memory 39. The RAM 33 is used by the controller 31 for the temporary storage of data. The operating system 40 may contain code which, when executed by the controller 31 in conjunction with RAM 33, controls operation of each of the hardware components of the API server 27.

The controller 31 may take any suitable form. For instance, it may be a microcontroller, plural microcontrollers, a processor, or plural processors.

The I/O interface 35 is configured to allow direct data input and output through a wired or wireless port or ports, for example to allow connection of a keyboard, display monitor, mouse controller or the like. The network interface 37 is configured to allow data input and output over a data network, and may be wired or wireless. Typically, the network interface 37 is a modem/router configured to communicate over an IP-based network using Ethernet or a related protocol such as IEEE 802.11. Referring back to FIG. 2, communication between the API control terminal 29 and the API server 27 is by means of the network interface 37, as is the communication between the customer terminal 23 and the API control terminal 29.

The API application 41 when run on the controller 31 provides an HTML (or similar e.g. an API specifically configured to show the documentation) web-based interface to permit access to the API documentation database 42, and in particular, to permit construction and/or initial entering of the API documentation, as well as later editing and customisation of the API documentation to create one or more functional views derived from technical message definitions. The API application 41 in particular provides an interface incorporating a viewing and editing suite as well as different menu options. The API application 41 also controls the format of API documentation display in terms of organisation into sections with a contents or index page through which sections can be accessed through hyperlinks. The API application 41 also incorporates customisation logic which applies predetermined rules to ensure consistency between different views in the event that changes are made by the API provider or are proposed by the API user. Changes made to API documentation can be saved to the API documentation database 42, and the changed version of the API documentation can be saved separately as a copy and associated with the API user that is using it. Multiple different versions of an API specification (modified for different API users) can be stored.

The API application 41 also provides the interface through which messages are received from the API user over channel 30.

The API application 41 is also configured to generate exported copies of the API documentation, if requested, in formats including HTML, PDF, or a machine-readable format such as JSON or XML.

The API application 41 may control user access, e.g. by means of IP address recognition, an electronic certificate and/or username and password authentication.

FIG. 4 schematically shows the API application 41 connected to the API documentation database 42. Functional modules of the API application 41 include an access manager 43 for providing the above-mentioned access control, a viewer/editor which is part of a Graphical User Interface (GUI) that provides the interface to the API application 41. Also provided is a customisation manager 47, which when run controls what user-changes can be made to copies of the API specification(s) currently held on the database 42, in accordance with customisation logic/rules 49 which set certain constraints or limitations on what can be changed, for example in a web-browser running on the API control terminal 29. Also provided is a change classification and reporting (CCR) module 50 which is an optional feature, relevant to a further embodiment to be described later on. Its function and operation will not be described in relation to the first embodiment, therefore.

Many programming languages already exist which may be suitable to build the API application 41. The preferred embodiment would use standard web-server technology and programming languages (for example PHP or Ruby) to deliver an API control terminal 29 capable of providing user interaction via a web browser. Such a solution would have the advantage of being able to operate on virtually any operating system 40.

### Technical API Specification

The API documentation database 42 stores a technical API specification. The technical API specification is the full API specification operated by the API provider counterparty system 21. It is termed a technical specification, as is the convention, because it comprises at the technical level protocol details for the full set of potential use cases that can be offered by the API provider. At the general level, it specifies a set of message types, and for each of these a set of fields and associated parameters which cover a superset of use cases. This information permits the developer at the API user end to configure their computer systems to talk to the API server 27.

In use, the API provider initially creates through the viewer/editor 45 the technical API specification. This may itself be based on a proprietary API, perhaps based on an industry standard one such as FIX or ISO 15022/20022 messaging formats. Industry standard protocols are designed as supersets to cover a wide range of use cases, and so the API provider's technical API specification will itself typically represent a subset of industry standards tailored for their own purpose.

The technical API specification presents at least the following information.
1. An introduction to the API, including the characteristics of the protocol and details of how to establish a connection to that API, e.g. including contact information, technical networking details, hours of availability and so on.
2. An index of technical messages, each uniquely identified by a Message Type Identifier.
3. A series of technical sections, presenting each technical message in turn, including:
   An introduction to the purpose and use of the message, and optionally examples of the message in use;
   A list of fields accepted in that message for this API, along with technical information on that field. The technical information presented for each field will vary depending on the base protocol used, but examples include parameters such as:
   (i) A technical identifier for the field, e.g. a tag number in FIX;
   (ii) Additional identifiers for the field, e.g. qualifiers for ISO 15022/20022 messages;
   (iii) The name of the field;
   (iv) An indication of whether the field must be present in messages or not;
   (v) Whether only a limited number of values are accepted for the field, and if so, a list of the values and their interpretation;
   (vi) The expected data type of the field content (e.g. integer, string or time stamp);
   (vii) The offset and length of the field, for defined-offset protocols.
   For each field in the message, the API provider can indicate that the field may be defaulted or manipulated upon receipt.

The viewer/editor 45 is configured to allow the API provider through the API control terminal 29 to construct the technical API specification either through direct entry, or by cloning (e.g. duplicating or cutting and pasting) an industry standard technical API specification, and editing that as required.

When the technical API specification is constructed and saved on the API documentation database 42, the viewer/editor 45 is able to supply the technical API specification to API users, e.g. customers of the API provider through an indexed web-page. Typically, the technical API specification will be separated into sections.

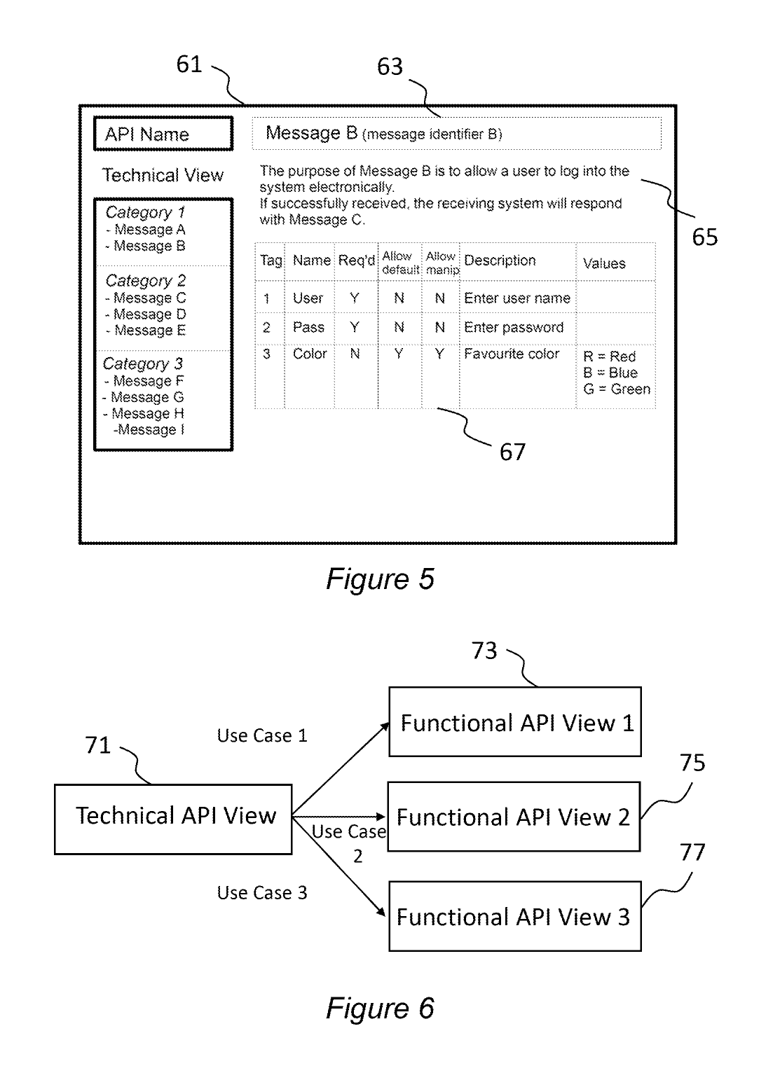

FIG. 5 is a screenshot 61 of a section of the technical API specification which includes those details indicated above. The example section given is that of “Message B”, which is the login message from the API user to the API application 41. There is, amongst other parts, a message identifier 63, an introduction 65 and list of fields 67. The list of fields 67 comprises the complete set of fields for Message B regardless of how an end-customer may use it in practice.

There are a number of API providers that already publish API documentation in this technical format. The significant majority of these documents are provided and distributed as PDF documents, with a small minority providing HTML versions on their websites.

In the present embodiment, the API application 41 provides this information in an electronic format that can be presented in a web browser that can be indexed on multiple pages, e.g. with selectable links on a contents/index page which leads to the appropriate part of the API technical specification. HTML, XML or other mark-up languages are examples of how the API technical specification can be represented.

The API application 41, particularly the customisation manager 47, enables editing/manipulation of the technical API specification to create one or more functional API views. These functional API view(s) is or are derived from the technical API specification, but take account of a selected use case. The concept is to provide a refined version of the technical specification, or part thereof, showing only those parts of the specification relevant for a given business use. This concept will be explained further below.

Functional API View

In many real-world scenarios, a single technical message may be used for multiple business purposes and each business use of a single technical message may place conditional restraints on the set of fields that may be entered, whether certain fields are required or not and/or the set of values which may be entered for certain fields.

For example, the FIX protocol defines a technical message (New Order-Single) used to communicate an instruction to buy or sell a financial security to another institution. The set of fields defined for that message include the following:

| Tag | Name | Required | Description | Values |
|---|---|---|---|---|
| 40 | OrdType | Y | The type of order | 1 = Market |
| | | | | 2 = Limit |
| 44 | Price | N | The maximum acceptable | |
| | | | price to buy, or the minimum | |
| | | | acceptable price to sell | |

A “Limit” order, indicated by OrdType=2, has the business interpretation of an instruction to buy or sell at a price no worse than an indicated price. For such orders, the Price field is required. A “Market” order, indicated by OrdType=1, has the business interpretation of an instruction to buy or sell at the best possible price in the market. For such orders, the sender should not send the Price field. Thus, the mandatory presence or absence of the Price field is conditional on the value of OrdType.

Multiple conditional relationships may exist within a single technical message, and the range of conditional relationships impacting message construction will vary according to the intended business in which the message is used.

Thus, the customisation manager 47 of the API application 41 is further configured to use the API technical specification stored in database 42 to generate one or more different functional API views for different business situations or use cases, which form a further view type within the documentation. FIG. 6 indicates this process schematically for a single technical API view which may be used in three different business or use scenarios; hence three functional API views 73, 75, 77 are created with each functional view being a different refined (more limited) version of the technical view. Functional views are created by cloning and modifying the technical message. By presenting the more limited technical API specification in the context of a specific business situation or use case, the resulting functional view(s) represent a strict subset of the technical API message. Each functional view 73, 75, 77 is stored on the API documentation database 42 and linked to its parent technical message 71.

In this way, the API documentation provided to the customer is immediately more readable and streamlined because they may only be interested in one or a subset of available use cases and therefore the functional view for the required business case(s) immediately tells them how to use the API without including redundant information. In short, the API application 41 in presenting the functional view(s) is configured to remove from view all fields or permitted field values which are not appropriate for the relevant business context.

The functional API view is configured manually from the API control terminal 29 by the API provider using the API application 41. The API application 41 is configured to run in a set-up mode in which user access to the customisation manager 47 permits the creation one or more functional views from the base technical view for selected parts of the full technical API protocol. In overview, this involves copying the selected technical view, and editing the copy to restrict the conditions for the given business context, before saving. Certain editing restraints are ensured by means of the customisation logic 49 associated with the customisation manager 47.

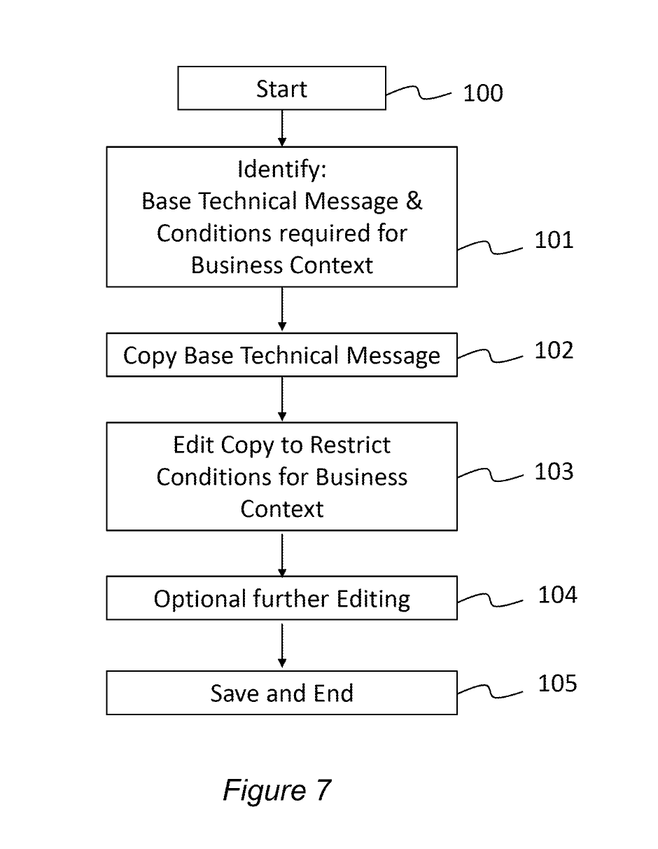

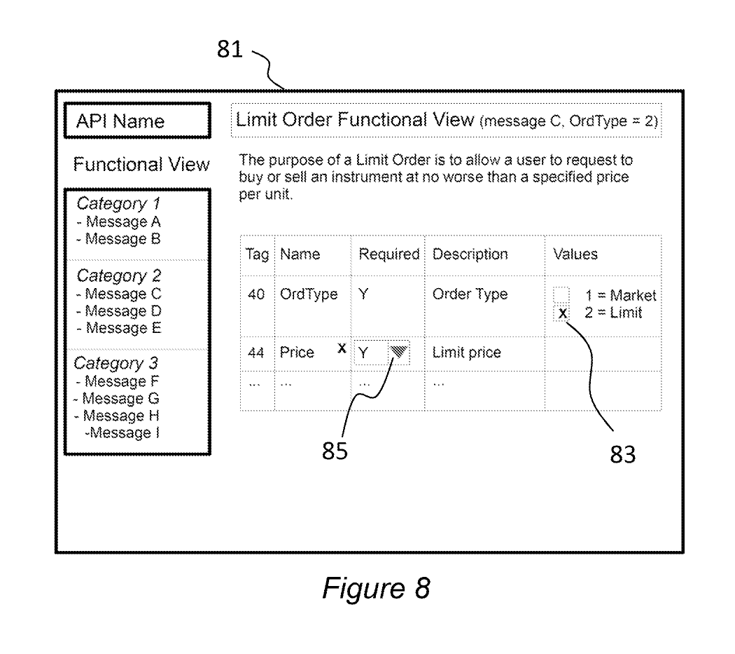

Referring to FIG. 7, a flow chart of the workflow involved in creating a functional view is shown. FIG. 8 is a screenshot 81 of the viewer/editing suite 45 during operation of the customisation manager 47 to create the functional view which is for a Limit Order.

Referring back to FIG. 7, the process starts at step 100, In step 101 the base technical message is identified to the customisation manager 47, as is or are the condition(s) required for the business context e.g. for New Order-Single we wish to create a functional view for a Limit Order message. In step 102, the customisation manager is commanded to generate a clone or copy of the base technical message, in this case the New Order, which is presented to the API provider for customisation. This copy is an ‘editable’ copy in that all or a subset of the fields are editable, e.g. by way of changing the text and/or using check boxes 83 and/or pull-down menus 85 Certain fields may be protected or constrained in terms of editing. Certain fields may be removed from the message using a check box or similar GUI interaction.

In step 103, the copy technical message is modified to restrict the conditions for the context. Referring to FIG. 8, we see that for this example this involves checking the check-box 83 against the Limit value for OrdType (and not for the Market value.) Further, because we know that a Limit order requires a price value, we set the pull-down menu 85 to Y for “yes”. Thus, the technical view has been constrained in two senses, but it will be appreciated that multiple dependencies and conditions can be applied according to the business context.

In step 104, further editing may be permitted by the customisation manager depending on the customisation logic which sets the rules on what is protected for given technical API message. For example, permitted editing may involve:
Editing the functional view description;
Removing any field indicated as not mandatory in the technical message;
Changing the description of any field, except where required for the functional view, but not to extend the range of permitted values or to change the interpretation of any field.

In step 105, the user saves and ends the customisation process and, from this, the functional view for a Limit Order is created.

Subsequently, the API Application 41 will present in HTML format the entire API specification which can be viewed in technical and functional views, each accessible (whether by the API provider or the customer) by means of selecting part of the specification and switching between technical and functional views. The functional view will be particularly useful in terms of understanding what is required for a business context.

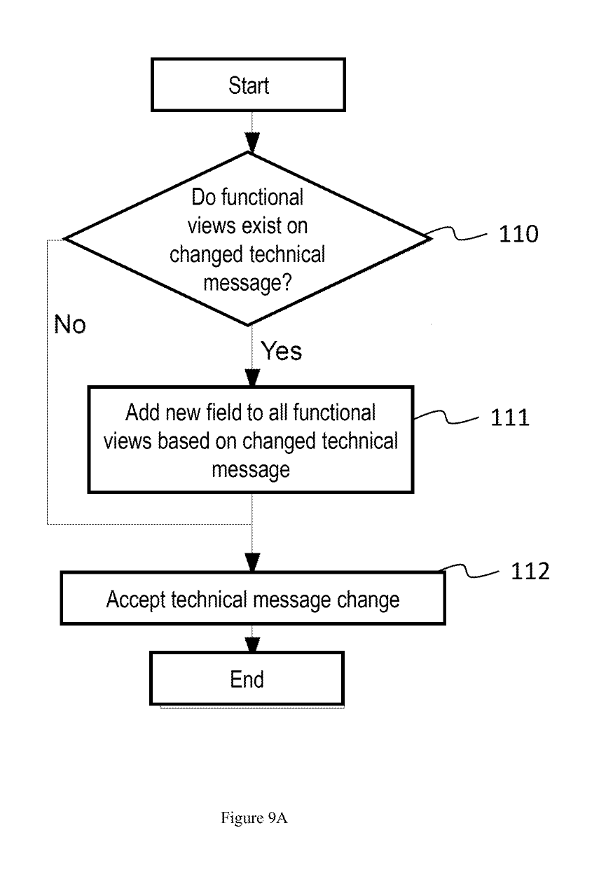

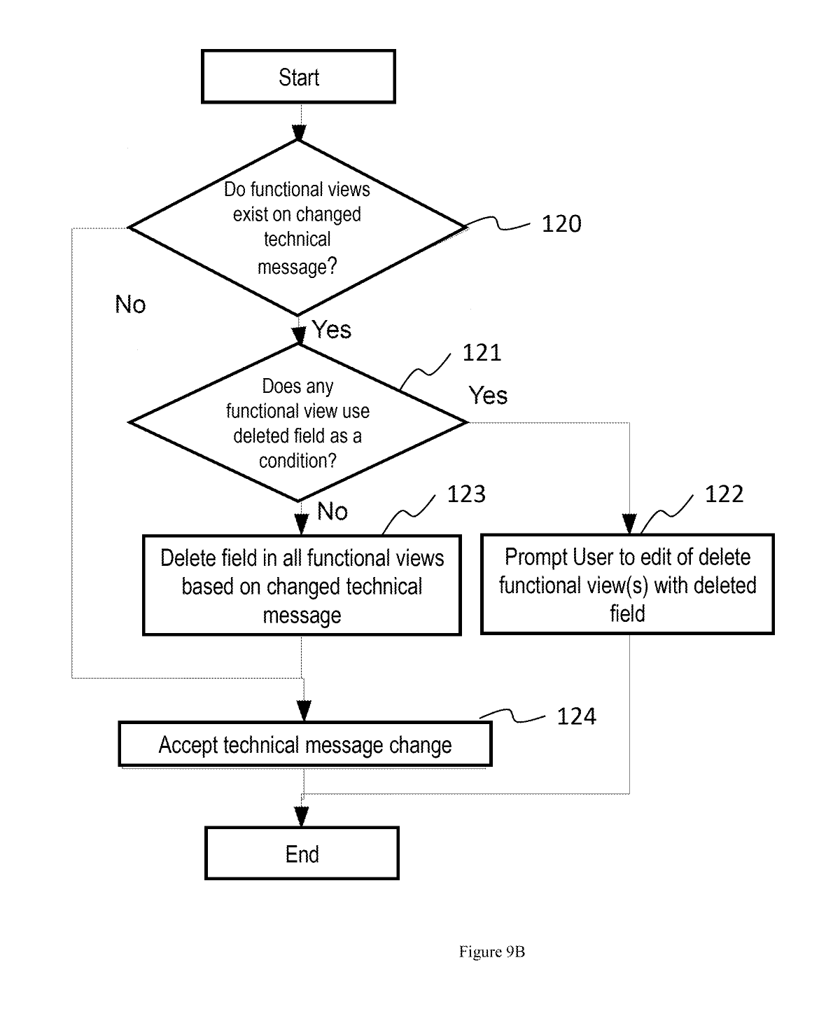

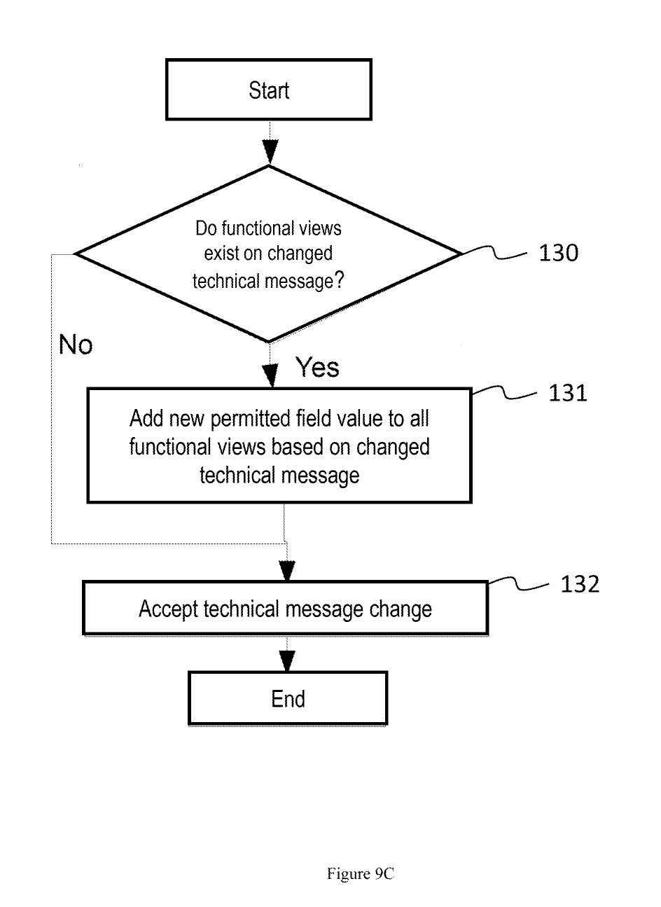

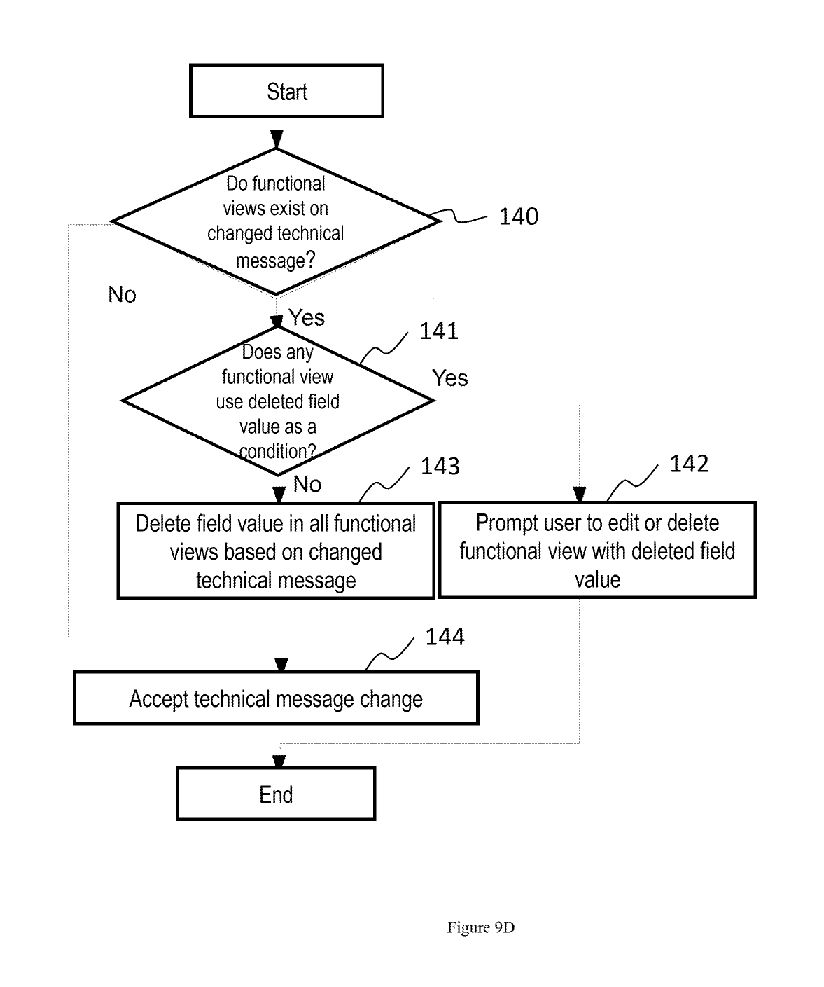

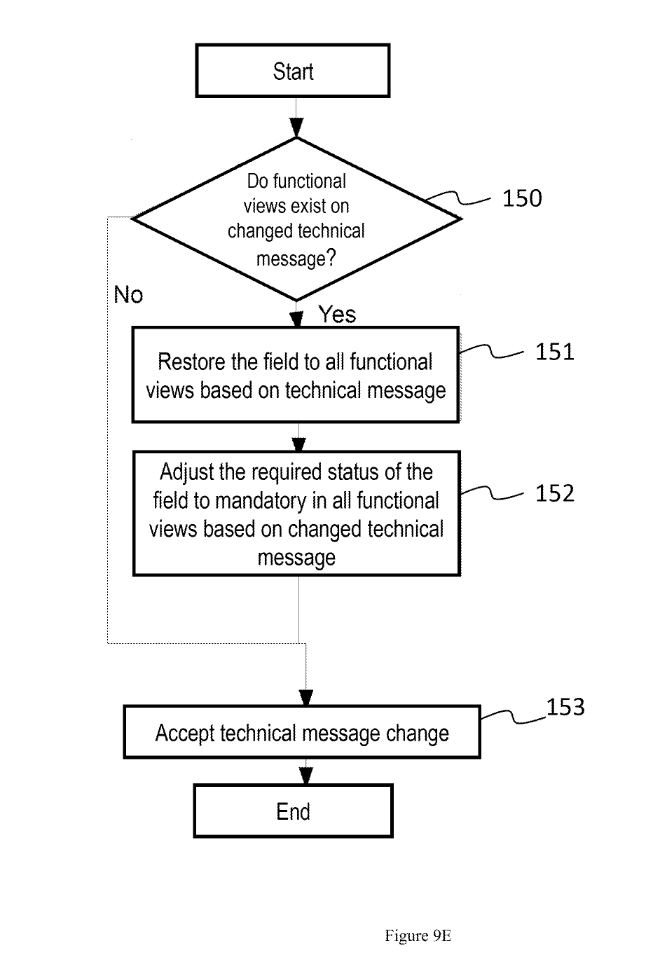

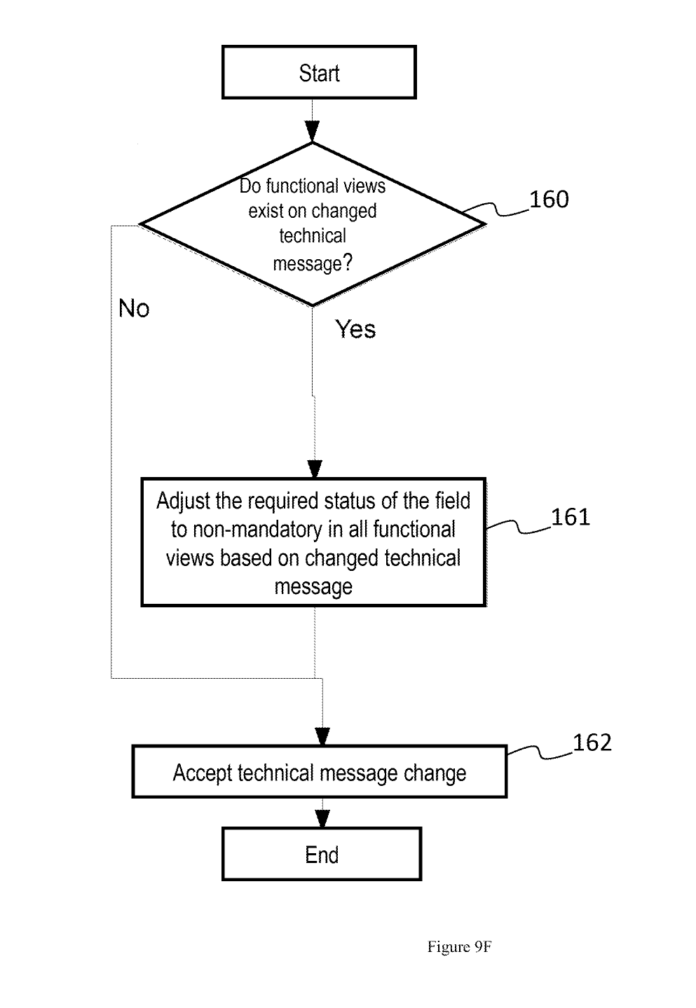

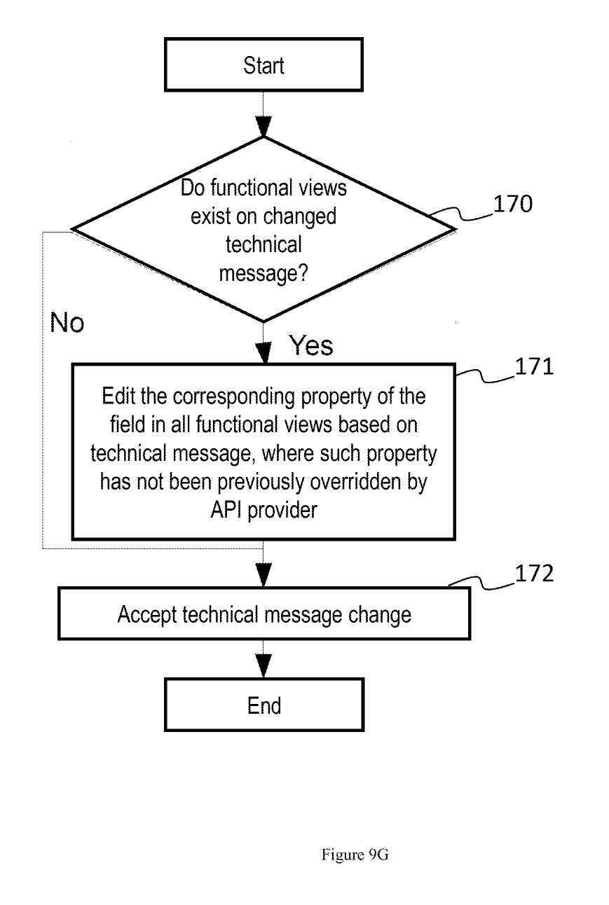

Further, the customisation manager 47 and logic 49 modules are configured when run to enforce consistency between the functional view of a message and the underlying technical message from which it is derived, and therefore tied to, bearing in mind that the API provider may wish to edit a technical API message without necessarily knowing if any functional views derive from it. FIGS. 9A to 9G indicate workflows that are set by the logic module to ensure this consistency. For ease of explanation, the start and end steps of each Figure are omitted from the following.

FIG. 9A indicates the logic rules applied by the customisation manager when a new field is added to a technical message in the editing/customisation process. In step 110, it is determined whether one or more functional views are associated with this technical message. If not, then the logic permits the change in technical message in step 111. If there is/are, then in step 112 the logic adds the new field to the or each functional view associated with the technical message.

FIG. 9B indicates the logic rules applied when a field is deleted from a technical message. In step 120, it is determined whether one or more functional views are associated with this technical message. If not, then the logic permits the change in technical message in step 124. If there is/are, then in step 121 the logic determines whether any functional view use the deleted field as a condition. If yes, then in step 122 the user is prompted to edit or delete the or each functional view having the deleted field.

If no, then in step 123 the field is deleted in all functional views tied to the technical message.

FIG. 9C indicates the logic rules applied when a new permitted field value is added to a technical message. In step 130, it is determined whether one or more functional views are associated with this technical message. If not, then the logic permits the change in technical message in step 131. If there is/are, then in step 132 the logic permits the new field value to be added to all functional views.

FIG. 9D indicates the logic rules applied when a permitted field value is deleted from a technical message. In step 140, it is determined whether one or more functional views are associated with this technical message. If not, then the logic permits the change in technical message in step 144. If there is/are, then in step 141 the logic determines whether any functional view use the deleted field value as a condition. If yes, then in step 142 the user is prompted to edit or delete the or each functional view having the deleted field value. If no, then in step 144 the field value is deleted in all functional views tied to the technical message.

FIG. 9E indicates the logic rules applied when a non-mandatory technical message field is made mandatory. In step 150, it is determined whether one or more functional views are associated with this technical message. If not, then the logic permits the change in technical message in step 153. If there is/are, then in step 151 the field is restored to all functional views based on the technical message. Then, in step 152 the required status of the field is adjusted to mandatory in all functional views based on the changed technical message.

FIG. 9F indicates the logic rules applied when a mandatory technical message field is made non-mandatory. In step 160, it is determined whether one or more functional views are associated with this technical message. If not, then the logic permits the change in technical message in step 162. If there is/are, then in step 161, the logic adjusts the required status of the field to non-mandatory in all functional views tied to the changed technical message.

FIG. 9G indicates the logic rules applied when editing any other technical message field. In step 170, it is determined whether one or more functional views are associated with this technical message. If not, then the logic permits the change in technical message in step 171. If there is/are, then in step 172, the logic adjusts the corresponding property of the field in all functional views tied to the technical message where such a property has not been overridden by the API provider.

To summarise, the first embodiment provides an electronic version of an API technical specification, sectioned and indexed, from which can be created by means of running the API application 41 on the controller 31 one or more functional views (tied to individual technical messages) which are restricted versions of the message appropriate to a given use case or business context. At the system or software application-level, the API provider is able to access the API technical specification, enter an editing mode provided by the API application 41, and thereafter create the different functional views based on copies of the relevant part of the technical view. This is by means of a viewer/editing system that enables the user through a web browser or dedicated GUI to open up a particular API message type, and input selections such as what is mandatory and what can be manipulated, as well as descriptive text. Restrictions on what can and cannot be edited is set by customisation logic, which defines rules and processes, in particular to ensure consistency given the interdependence between the technical and functional views of API messages. Once saved, the API specification that is made available to the API user at the customer terminal 23 comprises the technical API specification, through which technical views of individual sections/massage types can be viewed, and also the functional views appropriate to them which can be accessed in a highly convenient manner in that API users can quickly access those parts of the API specification that they are currently programming their systems to, and then see the fields and values they need to use without redundant information.

### Customised User View

In the first embodiment, there is described a system and method for creating an API specification, including technical and functional (more restricted) views, the creating steps being performed at the API provider end, i.e. using API control terminal 29.

In the real world, API users may only need a smaller sub-set of the functionality offered by the API provider's full specification.

Accordingly, in a further embodiment, the API application 41 permits users, that is customers of the API provider at the customer terminal 23, to further refine the API specification offered to them by means of proposing changes to the API provider's full version. A data message containing the proposed changes can then be received by the API application 41 for information purposes, or in some embodiments, for verification and approval/rejection. In this embodiment, it is assumed that verification is required by the API provider for such changes to take effect. If approved, the API provider updates the API documentation stored in the database 42 for that user, and the user will thereafter be able to access their customised API specification, including technical and functional views as before, in a so-called customised user view.

As will be explained, the API application 41 permits this function by providing access to the full API specification in a special ‘user customisation’ mode which permits developers at customer terminal 23 to electronically refine through an editing suite and/or check boxes and/or drop-down menus a copy of the full API specification document to indicate the changes they want. This will not of course affect the master copy stored in the database 42. Once the developer is ready to submit, a ‘submit’ operation is performed at the customer terminal 23 and the submission (together with identification of who the developer and customer is) is sent in a data message to the customisation manager 47 of the API application 41.

The customisation manager 47 is configured to notify the API provider of the received customisation request, which then undergoes a verification process to ensure the proposed changes will not cause problems or conflicts. The customisation manager 47 further maintains a status update field which appears when the developer of the API user logs-in to connect to the API control terminal 29, so that they can see what stage the customisation request is at, e.g. pending, awaiting verification, granted and so on.

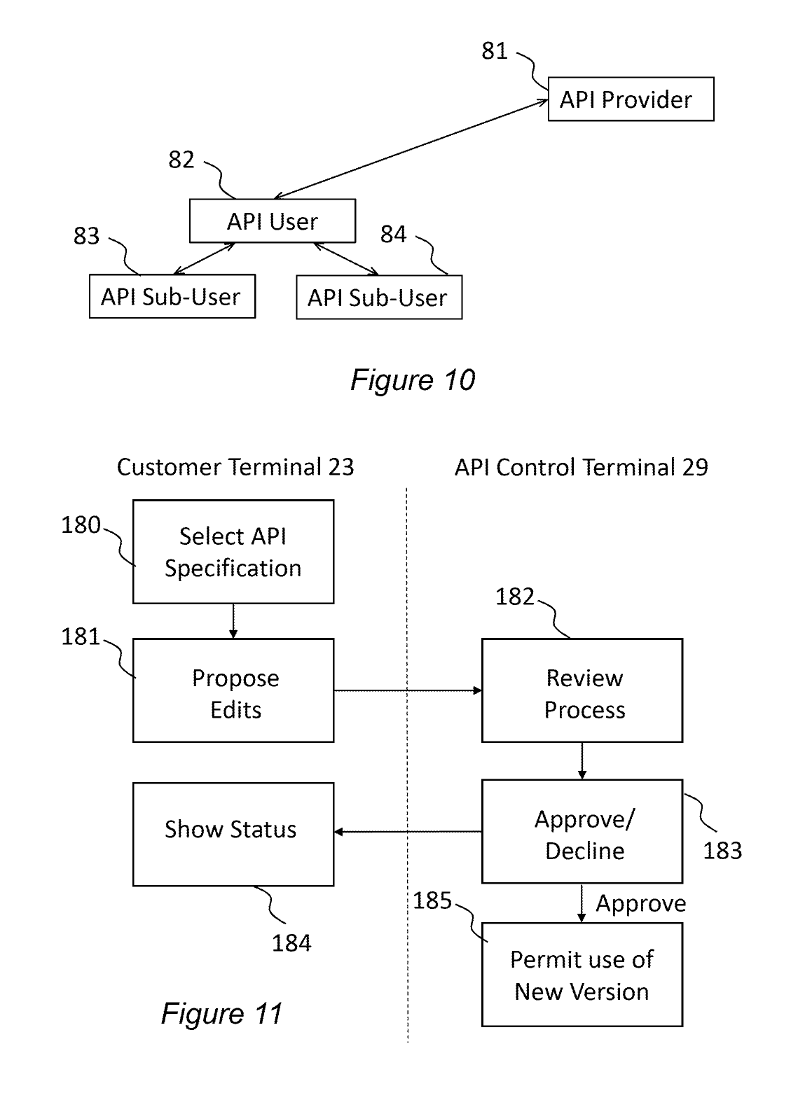

Referring to FIG. 10, there may be multiple levels of API sub users 83, each able to further restrict and refine the API documentation of a parent API user 82 to suit their specific needs within the organisation. For example, the technical and functional API documentation from the API provider (e.g. a broker or exchange) 81 may be viewed by a network provider (API user) 82 who will offer a subset of functionality to their customers 83 as software vendors. Software vendors (API sub-users) 83 would further be able to refine or adjust the customised user view generated by the network provider.

Referring to the process diagram of FIG. 11, requesting and creating a customised user view 1 is performed at the customer terminal 23 which accesses and interacts with the API Control Terminal 29 (specifically the API Application 41) that presents the ‘base’ API documentation (in electronic form as in the previous case) through a GUI which may be presented on a web-browser or dedicated GUI program.

It will be appreciated that the API documentation may or may not already be restricted based on customisation performed at the API control terminal 29, and will include technical and functional views.

The process of creating the customised user view begins in step 180 with the API user selecting the set of technical messages and/or functional views offered by the API provider. The API user may then perform a variety of actions within the customised user view to further refine it for their own purpose (step 181). This may include:
1. Adding notes to the main document introduction (editing the original text is not permitted);
2. Adding notes to the description of any technical message or functional view (editing the original text is not permitted);
3. Adjusting fields within any technical message or functional view to:
   Remove any non-mandatory field from view
   Adjust non-mandatory fields to require their mandatory presence
   Add additional notes to the field description (but not edit the original text)
   Restrict the set of field values permitted by the API Parent Document
   Request to default any field marked by the API Parent Document as suitable for default, indicating the value to which the value should be defaulted
   Request to manipulate any field marked by the API Parent Document as suitable for manipulation, indicating the logic to be used by the API provider using an agreed logical syntax
   Mark any field as suitable for default by any sub-users of the Customized View
   Mark any field as suitable for manipulation by any sub-users of the Customized View

Note that in some embodiments, these possible changes that can be regarded as ‘safe’ changes because the API provider gives through a user interface the ability for API users to request these changes, and the result of making such changes will not require the API itself (in the API server 27) to change in order to handle messages from the customer terminal 23. Again, for this reason, the need for verification by the API provider is in some embodiments optional (it can be for information purposes only) although in the present case we assume that verification is required.

When ready to submit the proposed customisation, a request message is submitted to the API control terminal 29. A verification process is performed at step 182. A status of the verification process is indicated to the customer terminal 23 in step 184. If the verification process declines the request, the API user informed, e.g. by email or within the browser. If the verification process is approved, the API documentation is updated as a copy, stored on the database 42 and the API user similarly informed and permitted to access the new API documentation (which comprises the technical and functional views requested).

In general, requests to default or manipulate fields upon request may be subject to approval by the entity which constructed the API Parent Document (the API provider in the case of a direct user, or the parent user in the case of a sub-user customized view). The API provider may also have the ability to view, create, edit or delete user-customised views directly in the API Application 41 on behalf of specific users should this be required.

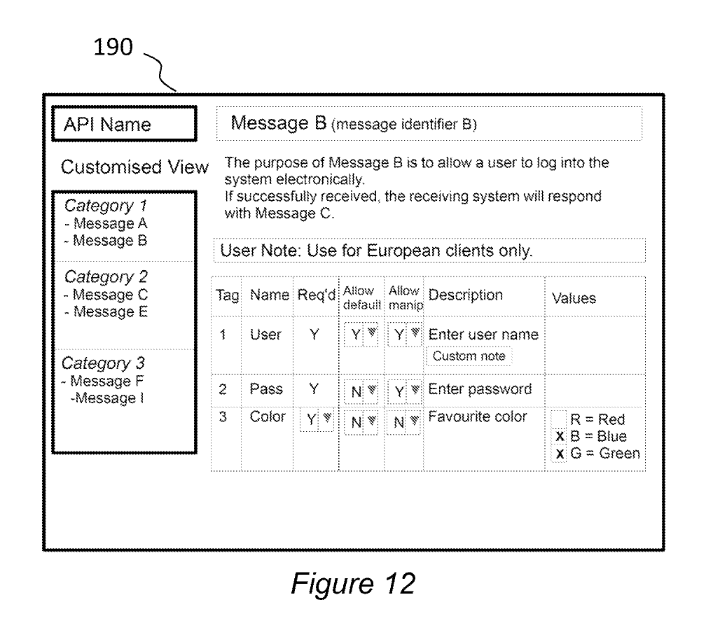

FIG. 12 presents an example layout of the editor 190 presented at the API user location (e.g. the customer terminal 23) by the API application 41 for the creation of a user customised view. It is in effect an editable version of either of the technical or functional views for the API documentation, with the editing options being restricted to those considered ‘safe’ which are mentioned above. These safe areas can be highlighted or visually indicated. As will be seen, certain fields or elements of fields are required and others may be edited. For example, in the Customised User View, Tag 1 (User) is a required field, but the values of “Allow Default”, “Allow Manipulation” and “Description” can be modified by way of pull-down menus and text editing. Check boxes are made available for the Colour field.

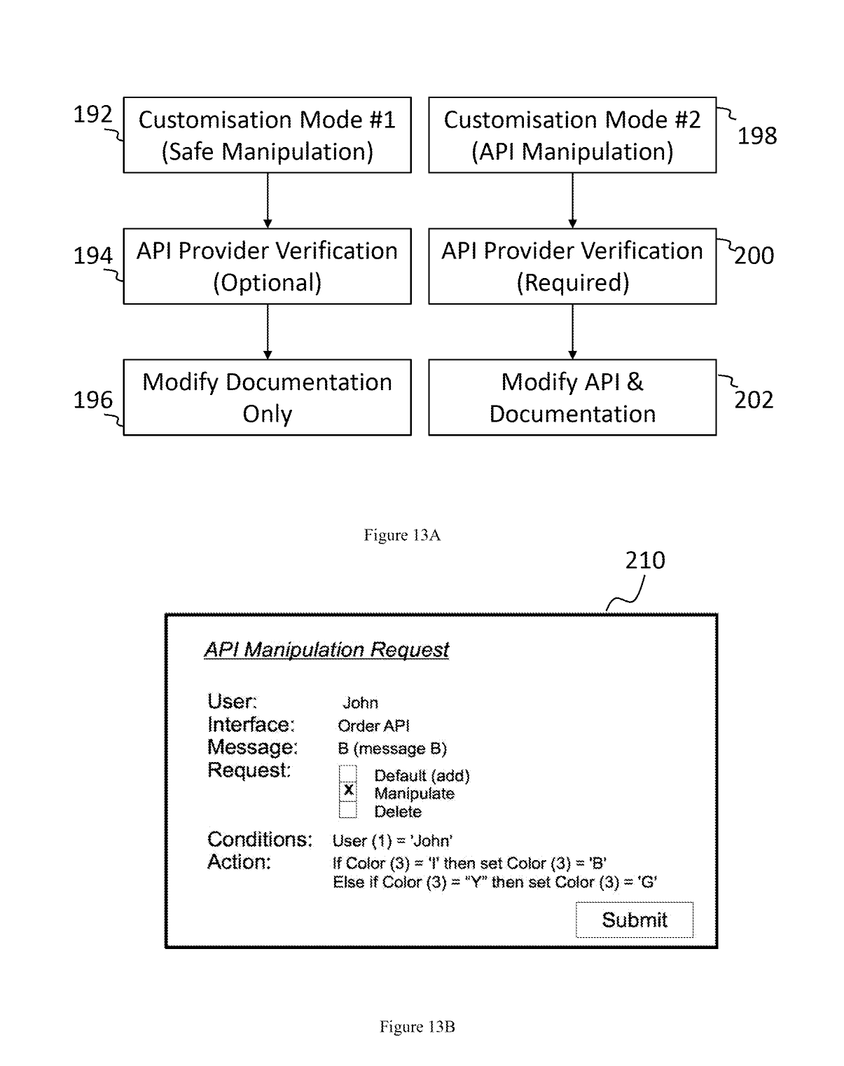

In a further embodiment of the customised user view, the API application 41 permits requests for customisations outside of the above described ‘safe’ options, which ultimately will require a modification to the API server 27 in order that the way it handles certain messages from the customer terminal 23 is changed. In this sense, it may be that the API user cannot adhere to the API provider's API specification in the API server 27 and, in this embodiment, the API application 41 is set-up to accept requests for API manipulation. FIG. 13A illustrates schematically the two modes of user customisation. The first mode 192 is that previously described, whereby the API application 41 permits safe manipulation via the user interface 190, which then (optionally) goes through verification 194 and results in modification of the documentation only 196. The second mode 198 permits the API user to request manipulation of the API, which does require API provider verification 200 and, if approved, results in modification of the API on API server 27 insofar as how it handles messages received from the customer terminal 23, as well as the API documentation.

In both modes, it will be appreciated that the API user can request and obtain customisation through interactive changes made to the available documentation.

Examples of when user manipulation of the API is required can include:
1) The API provider documentation (technical or functional view) indicates that tag 999 is mandatory but the API user's software cannot send it; accordingly, the manipulation requested may be to modify the API to always assume a value of “A” for tag 999.
2) The API provider documentation (technical or functional view) indicates colours “blue” and “red” as options, but in the API user's software, they are “indigo” and “pink”; accordingly, the manipulation requested may be to modify the API to map “indigo” to “blue” and “pink” to “red”.
3) The API user's system automatically sends a field 888 with a timestamp in it, but the API provider's documentation indicates that it does not recognise nor want this field; accordingly, the user requests them to always delete this field.

Approval for such changes received through a suitable form through the documentation channel 30 results in a change to how the API server 27 interprets messages received from the customer terminal 23.

FIG. 13B presents an example layout of the form 210 presented at the API user location (e.g. the customer terminal 23) for the creation of a request to default or manipulate a field in the second mode 198, indicating the user requesting the change, the API to be manipulated, the technical message or functional view considered, the set of conditions under which the default/manipulation should occur, and the action to be performed if the conditions are met. This form may also be used to request the automatic deletion of fields presented on incoming messages (which may or may not be available in the API provider specification). For example, if messages from a user contain a field which is not supported in the API, then the delete function could be used to remove this field from the message ahead of the transaction server 25.

Once constructed, the customised user view can be saved for later retrieval, and may serve as a base for further customised user views by sub-users.

Allowing API users the ability to customise API documentation for their own purposes, to add notes and to allow adjustment for sub-users significantly increases the efficiency of documentation communication. Since the preferences and adjustments to create the customised user view is or are captured by the system 29, this information is available to the API provider allowing them to better understand the requirements and preferences of their customers in the form of feedback.

The hardware to implement the customised user view facility is the same as for the first embodiment, with the API application 41 being modified to provide this client-end customisation facility.

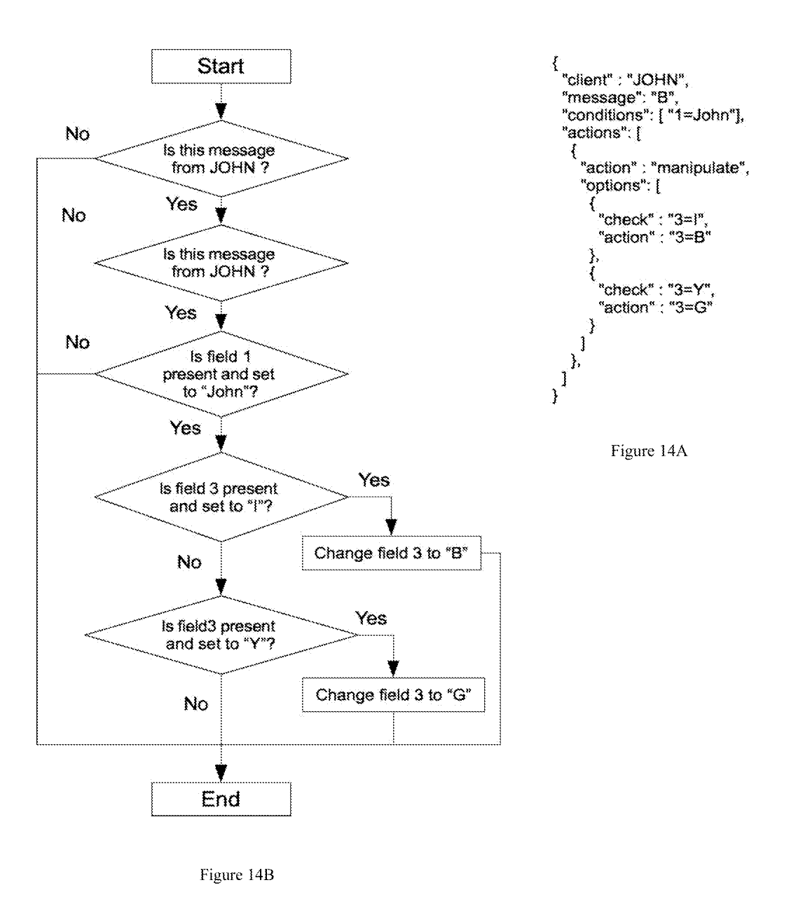

### Representation and Processing of User-Specified Overrides (Second Customisation Mode 198).

Where a default or manipulation request has been granted, the API Server 27 will perform the requested actions upon receipt of a message from the Customer Terminal 23. To perform this action, API Server 27 will receive from the API control terminal 20 details of approved overrides in a machine-readable extract, capable of being uploaded and used in message handling. The format of this extract will depend on the requirements of the API Server 27. FIG. 14A illustrates one possible format in pseudo code.

FIG. 14B is a process diagram indicating the steps of the pseudo code, using an example of how the API Server 27 applies approved, user-specified overrides with reference to the example user customisation request in FIG. 13B.

In a first step 220, it is determined if this is message is from client JOHN (which is the name given in this case to the API user). If not, the process ends. If it is, step 221 determines if the message is of technical message type B. If not, the process ends. If it is, step 222 determines if the condition stipulated in the request (and any conditions imposed by a functional view to which the request relates) are met. If not, then the process ends. If it is, then the API Server 27 attempts to default or manipulate received fields according to the actions specified. Step 223 determines if field 3 is present and set to a value of “I”. If it is, then this field's value is manipulated to “B” in step 224, and the process ends. If step 223 is not satisfied, then step 225 determines if field 3 is present and set to a value of “Y”. If it is, then the field's value is manipulated to “G” in step 226 and the process ends.

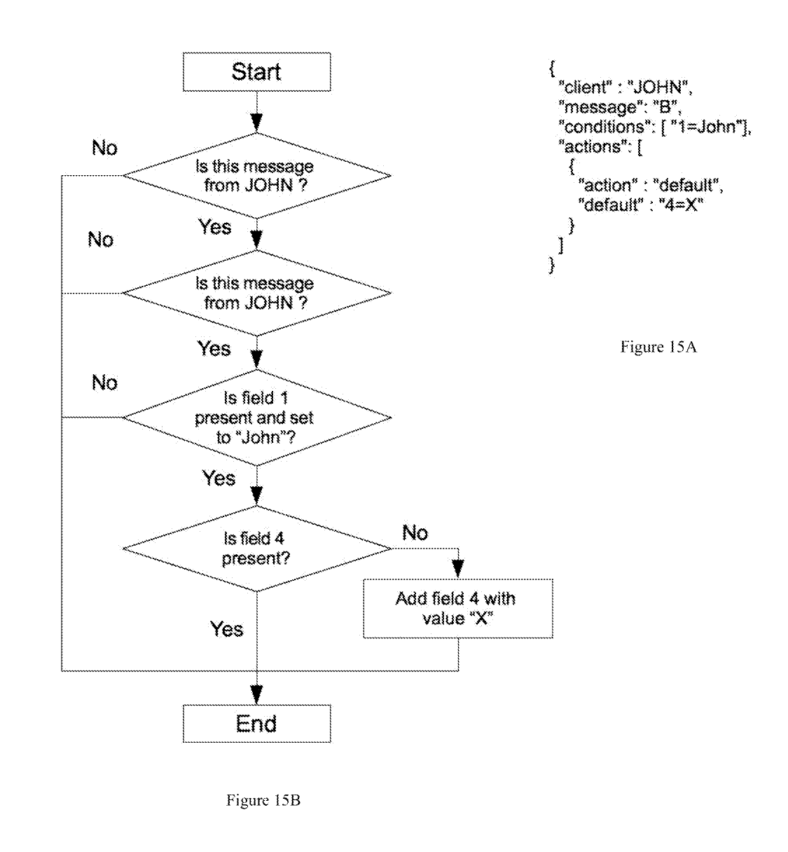

FIGS. 15A and 15B present, respectively, pseudo code and workflows for defaulting fields. Here, step 230 is used to decide if field 4 is present. If so, the process ends. If not, then in step 231 the value X is added to field 4.

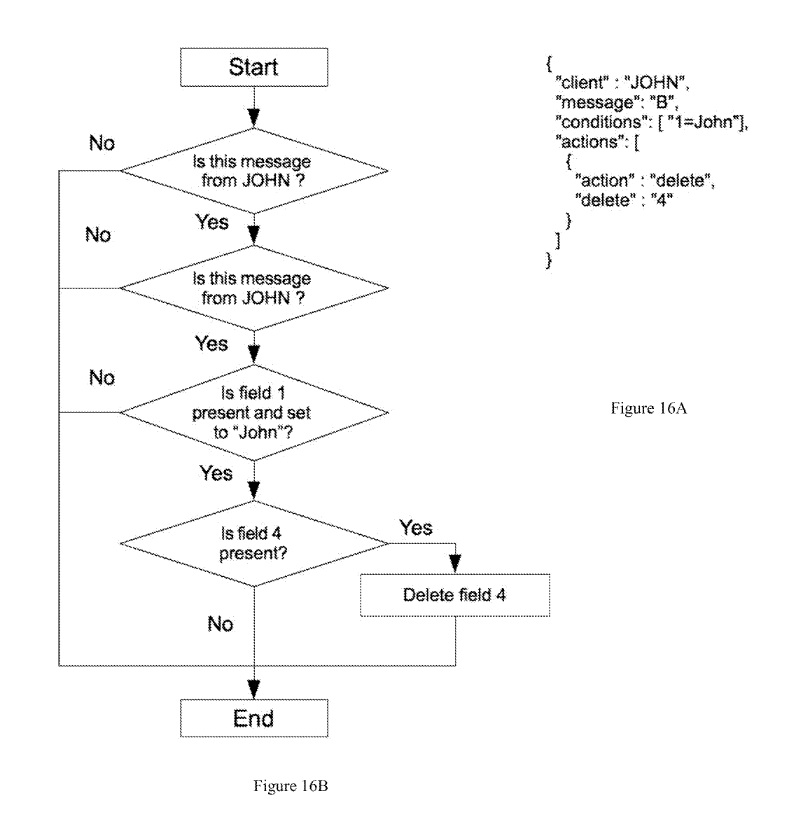

FIGS. 16A and 16B present, respectively, pseudo code and workflows for deleting fields. Here, step 240 is used to decide if field 4 is present. If not, the process ends. If so, then in step 241 field 4 is deleted.

The API server 27 will apply all relevant defaults and overrides before passing the (potentially adjusted) message to the transaction server 25 for processing. The transaction server 25 may respond back with a message destined for the customer terminal 23, which also passes through the API server 27, and may also be subjected to the field-level overrides described above. For audit trail purposes, the API server 27 would store the original and adjusted messages as a result of this processing.

Most API providers will provide systems which accept user-specific configurations and overrides as part of their processing. Conventionally, these are manually adjusted in telephone or email discussion with the API user, and are completely distinct from the API documentation. In the present embodiment, by capturing the API user's preferences (in the choices made when constructing the customised user view) and the capture of approvals for field overrides and manipulations, the system is capable of linking documentation (the customized user view) with system configurations, eliminating manual back-and-forth processes which can cause errors, and this also improves efficiency.

### Exporting API Documentation

The API application 41 in some embodiments is configured to export customised user views (including all adjustments and approved overrides indicated in the above description) in a variety of fixed formats for use outside the system. This is performed automatically by the API application 41 in response to user request at their GUI. These formats may include:
a PDF or HTML format (using a pre-defined, branded templates of the API Parent);
A format suitable for reading with a spreadsheet application, e.g. .XLS, .XML, .XMLSS.
Suitable industry-standard, machine-readable formats such as FIXML, ISO 15022/20022 XML, or FIXatdl

The mechanism by which APIs are exported will vary according to the target documentation type. A common approach, however, is to construct a series of export templates in advance (one for each export type), and then inject the API data into the relevant template at the time of the export. For example, PDF documentation may be constructed by preparing a series of branded LaTeX template(s) in advance, and then dynamically adding data into the templates and compiling the resulting file into a PDF structure. The API control terminal 29, particularly the API application 41, is configured to store the template(s) and also to import or inject the API data into the relevant template, e.g. in response to a user command, and to export the resulting PDF. A further method is the use of standard document exporting software for converting text files or HTML files into PDF, XML, XLS or similar.

Thus, the API application 41 provides the ability to automatically create documentation specific to a user's preferences and use of an API.

Further, some of the machine-readable extracts may be designed to allow system configuration by the API user—for example the FIXatdl standard is designed to control the layout and appearance of the form used by the API user to submit orders to an API provider. In the present API application 41, by capturing the API user preferences and overrides, the system will be able to create user-specific exports, such as user-specific FIXatdl forms which only present the business scenarios that they use.

### Generation of Custom, Prioritised API Change Alerts

Over time, the functionality offered by an API provider may change, necessitating an update to published documentation. The existing process for distribution of updated documentation and the processing of that documentation is labour-intensive and error-prone. Distribution is typically achieved through updating a PDF document on a corporate website, possibly accompanied by an email alert to a set distribution list. The recipient must then download the document and manually compare it to the last version implemented by their system, and discern any changes that may be required and their respective urgency.

Since the system presented here has the data required to understand which elements of the API a particular user has interest in (by virtue of their customised specification), in a further embodiment, the API application 41 is configured to calculate the importance of a given change made by the API Provider on each of the customer systems 23 of their users and for change reports to be generated and issued to API users. This functionality is provided by, in this embodiment, an additional component shown in FIG. 4 which is the change classification and reporting module 50, hereafter CCM for short.

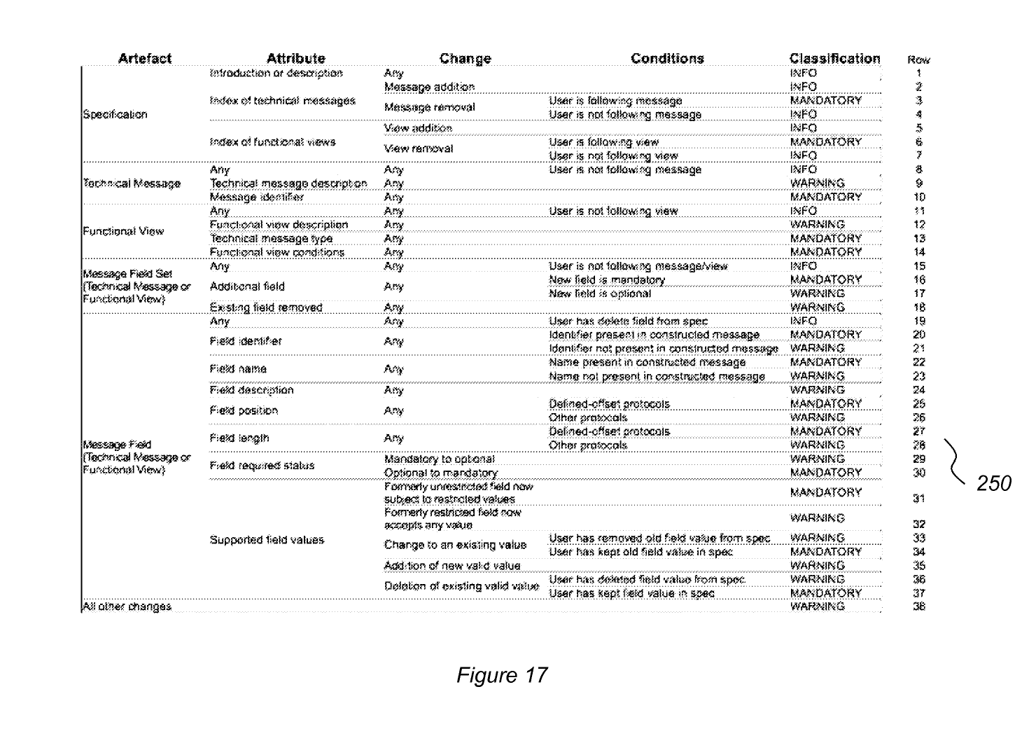

In operating the CCM 50, each change by the API Provider is given a classification rating based on an impact matrix constructed by the API Provider. An example of such a matrix 250 is presented in FIG. 17, which has headings of “artefact”, “attribute”, “change”, “conditions” and “classification”. The process proceeds by iterating over the set of user-defined specifications, and evaluating the change in the context of the user settings to look up the correct classification from a list of pre-defined values. For example FIG. 17 indicates that:
a change to the introduction of a specification is classified as “INFO” for all users (row 1)
the addition of a new technical message is classified as “INFO” for all users (row 2)
the deletion of an existing technical message is classified as “MANDATORY” for all users which have selected that technical message as part of their user-defined specification (row 3), but “INFO” for all others (row 4)
the addition of a new field in a message is classified as “MANDATORY” if the new field is a mandatory field (row 16), but “WARNING” if it is optional (row 17).

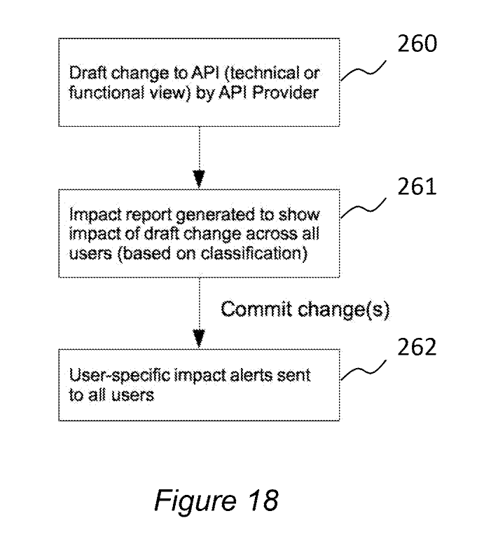

The classification approach is used by the CCM 50 to generate user-specific impact reports, the process for generating such a report being shown in FIG. 18. Draft changes by the API Provider in step 260 are assessed according to the classification approach presented in FIG. 17, and an impact report is generated (step 261) detailing the aggregate impact of the change on users. This report may include a count of impacted users by classification and a list of the users in each classification. The purpose of this report is to allow the API provider receiving the impact report to assess the proposed change prior to making it, and to identify any additional changes that may be required to mitigate the effects, such as adding additional user-specific overrides.

Once the API provider commits one or more changes, the API controller 23 would alert automatically in step 262 each of the users in turn via an appropriate mechanism (such as email) to the change. The content of the alert may include the following detail for each of the changes made:
1. the classification of the change for their user profile
2. the artefact that has been changed
3. the old and new values of the changed artefact (if appropriate)
4. a copy of the updated user-specific documentation after the change, in the manner described previously.

It will be appreciated that the above described embodiments are purely illustrative and are not limiting on the scope of the invention as recited in the appended claims. Other variations and modifications will be apparent to persons skilled in the art upon reading the present application.

Moreover, the disclosure of the present application should be understood to include any novel features or any novel combination of features either explicitly or implicitly disclosed herein or any generalization thereof and during the prosecution of the present application or of any application derived therefrom, new claims may be formulated to cover any such features and/or combination of such features.

Although the present disclosure has been described with reference to one or more examples, workers skilled in the art will recognize that changes may be made in form and detail without departing from the scope of the disclosure and/or the appended claims.

1. A method of providing a programming interface (PI) specification which defines in text form the format of data messages for communication between financial services counterparties for making transactions, the method comprising the following acts performed by a PI controller device:
(i) providing in data form a base PI specification for display on a computer;
(ii) sending said base PI specification, or a copy thereof, to a computer for display and editing through a user-interface;
(iii) receiving from said computer at least one edit made to said base PI specification through the user-interface;
(iv) providing a sub-specification of said base PI specification incorporating the at least one edit made in (iii); and
(v) making the sub-specification available for viewing at remote computers over a data network.

2. The method of claim 1, wherein step (ii) further comprises indicating through the user-interface one or more defined parts of said base PI specification that can be edited.

3. The method of claim 1, wherein step (i) comprises providing a base PI specification comprising a plurality of message types, and, for each message type, a technical specification comprising a plurality of fields and associated parameters, and wherein step (iii) comprises receiving at least one edit which defines for a message type a restricted version of the technical specification limited for a respective use case.

4. The method of claim 3, further comprising, prior to step (v), providing a selectable indication of the respective use case for display at a remote computer, selection of which makes the associated sub-specification available for viewing in step (v).

5. The method of claim 1, wherein the edit received in step (iii) is associated with a given user or user-group, and wherein step (iv) comprises providing the sub-specification in response to detecting a display request received from said user or user-group.

6. The method of claim 5, wherein the edit received in step (iii) is associated with a first user-group, and in which the method further comprises receiving at least one edit to the sub-specification PI to be associated with a subset of said first user-group, and subsequently providing a second sub-specification to the subset user(s).

7. The method of claim 1, wherein step (ii) comprises sending said base PI specification, or copy thereof, as an editable form or table.

8. The method of claim 3, wherein step (ii) comprises sending said base PI specification, or copy thereof, in editable form which enables textual notes to be added to the technical specification of a message type.

9. The method of claim 3, wherein step (ii) comprises sending said base PI specification, or copy thereof, in editable form which enables the restriction of field parameters.

10. The method of claim 3, wherein step (ii) comprises sending said base PI specification, or copy thereof, in editable form which non-mandatory fields and/or associated parameters to be made mandatory.

11. The method of claim 1, further comprising, subsequent to step (iii), the step of determining if a received edit is permitted and in step (iv) providing a sub-specification including only permitted a edit.

12. The method of claim 11, wherein predetermined rules are provided to automatically determine whether an edit is permitted.

13. The method of claim 1, further comprising generating computer-readable instructions for modifying a programming interface in response to an edit received.

14. The method of claim 1, wherein the base PI specification and sub-specification is provided in a mark-up language for display in a graphical user interface (GUI) at a remote computer.

15. The method of claim 1, further comprising generating in response to a remote request a fixed version of the sub-specification and providing access to said fixed version by a remote user.

16. The method of claim 1, further comprising the step of proposing edits to the base PI specification and assessing the impact of said proposed edits on the or each sub-specification associated with the base PI specification.

17. The method of claim 1, wherein the method is performed by the PI controller device at a computer system of, or associated with, a PI provider, wherein step (ii) comprises sending said base PI specification to a computer of a PI user, step (iii) comprises receiving the at least one edit from the PI user computer, and step (v) comprises making the sub-specification available for viewing at the PI user computer.

18. A system configured to provide a programming interface (PI) specification which defines in text form the format of data messages for communication between financial services counterparties for making transactions, the system comprising:
one or more physical computers in communication with physical data storage, the one or more processors being configured to:
(i) provide in data form a base PI specification for display on a computer;
(ii) send said base PI specification, or a copy thereof, to a computer for display and editing through a user-interface;
(iii) receive from said computer at least one edit made to said base PI specification through the user-interface;
(iv) provide a sub-specification of said base PI specification incorporating the at least one edit made in (iii); and
(v) make the sub-specification available for viewing at remote computers over a data network.

19. A non-transitory computer readable medium having stored thereon instructions that, when executed by a computer system having computer storage, cause the computer system to perform a method of providing a programming interface (PI) specification which defines in text form the format of data messages for communication between financial services counterparties for making transactions, the method comprising the following acts performed by the computer system:
(i) providing in data form a base PI specification for display on a computer;
(ii) sending said base PI specification, or a copy thereof, to a computer for display and editing through a user-interface;
(iii) receiving from said computer at least one edit made to said base PI specification through the user-interface;
(iv) providing a sub-specification of said base PI specification incorporating the at least one edit made in (iii);
(v) making the sub-specification available for viewing at remote computers over a data network.

20. A method comprising:
(i) storing in a non-transitory computer-readable medium a PI specification which defines how a user financial services counterparty should send data to a provider counterparty over a data communications network;
(ii) providing access to a displayable, interactive version of said PI specification to enable editing of said PI specification;
(iii) receiving with a PI controller device one or more edits made to the interactive version of said PI specification and generating a sub-specification incorporating the or each edit; and
(iv) providing access to the sub-specification over a data communications network.
